(19) United States
(12) Patent Application Publication
(10) Pub. No.: US 2020/0355093 A1
(43) Pub. Date: Nov. 12, 2020

(54) CASING OF A TURBOCHARGER AND TURBOCHARGER

(71) Applicant: MAN Energy Solutions SE, Augsburg (DE)

(72) Inventors: Steffen BRAUN, Augsburg (DE); Daniel ALBRECHT, Augsburg (DE); Harald DENKEL, Bear (DE); Stefan WEIHARD, Augsburg (DE); Bernd HAAS, Neusass (DE); Johannes NIEBUHR, Augsburg (DE); Urban SPATZ, Neusass (DE)

(73) Assignee: MAN ENERGY SOLUTIONS SE

(21) Appl. No.: 16/860,621

(22) Filed: Apr. 28, 2020

(30) Foreign Application Priority Data
May 8, 2019 (DE) 10 2019 111 899.9

(51) Int. Cl. F01D 25/24

(52) U.S. Cl. CPC F01D 25/243; F05D 2240/14; F05D 2220/40

(57) ABSTRACT

A casing which surrounds a housing of the turbocharger has a first casing body, which emanating from a first side of the housing can be pushed onto the housing in an axial direction. The first casing body has an axial casing segment adjoining the housing adjoining the first side axially outside, and multiple casing segments adjoining the housing radially outside. A second casing body can be pushed onto the housing in the axial direction has an axial casing segment adjoining the housing adjoining a second side axially outside, and a radial casing segment, which adjoins the housing radially outside, covers the first casing body radially outside in sections and is connected to the first casing body. Multiple supports each has first sections, via which the respective support can be mounted to the housing. Each support has second sections), via which the first casing body is mounted to the respective support.

### BACKGROUND OF INVENTION

### 1. Field of the Invention

The invention relates to a casing of a turbocharger and to a turbocharger.

### 2. Description of Related Art

The fundamental construction of a turbocharger is known to the person skilled in the art addressed here. A turbocharger comprises a turbine, in which a first medium is expanded, a compressor, in which a second medium is compressed, namely utilising the energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing is connected on the one hand to the turbine housing and on the other hand to the compressor housing. In the bearing housing, a shaft is mounted via which the turbine rotor is coupled to the compressor rotor.

During operation of a turbocharger there is a risk that a rotor, for example the turbine rotor or the compressor rotor, of the turbocharger breaks and fragments of the rotor strike through the relevant housing, i.e. the turbine housing or the compressor housing. There is then the risk that the fragments of the turbocharger enter the surroundings. In order to take into account this problem of the bursting of a rotor of the turbocharger, the respective housing in turbochargers known from practice is designed such that a failure of the respective housing need not be expected and even during the breaking of the respective rotor, fragments of the same cannot strike through the respective housing. However, the weight of the turbocharger is increased because of this.

To unnecessarily increase the weight of the turbocharger and to protect turbochargers already employed in the field from fragments of a rotor striking through into the surroundings, it is known from practice to equip a turbocharger with a casing that surrounds a turbine housing and/or a compressor housing and/or a bearing housing of the turbocharger radially outside and axially outside at least in sections.

### SUMMARY OF THE INVENTION

Casings for turbochargers known from practice comprise axial casing segments which, on axial sides of the housing to be encased, adjoin the housing to be encased axially outside. Furthermore, casings known from practice comprise at least one radial casing segment, which adjoins the housing to be encased radially outside and extends between axial casing segments located opposite one another. There is a need for a casing for a turbocharger that has a simple construction and additionally can be easily mounted to the housing to be encased, but beyond this provides an unlimited burst protection.

One aspect of the invention is based on a new type of casing of a turbocharger and a turbocharger having such a casing.

The casing of the turbocharger surrounds a housing to be encased such as a turbine housing and/or a compressor housing and/or a bearing housing of the turbocharger at least in sections. The casing comprises a first casing body, which originating from a first side of the housing to be encased, can be pushed onto the housing to be encased in the axial direction, wherein the first casing body comprises at least one axial casing segment that adjoins the housing to be encased adjoining the first side axially outside, and multiple radial casing segments, that adjoin the housing to be encased radially outside. Furthermore, the casing comprises a second casing body that, originating from a second side of the housing to be encased, can be pushed onto the housing to be encased in the axial direction, wherein the second casing body comprises at least one axial casing segment, that adjoins the housing to be encased adjoining the second side axially outside, and at least one radial casing segment, that adjoins the housing to be encased radially outside, covers the first casing body radially outside in sections and is connected to the first casing body. Furthermore, the casing comprises multiple supports, wherein each support comprises first sections, via which the respective support can be mounted to the housing to be encased, and wherein each support comprises two sections, via which the first casing body is mounted to the respective support.

As explained above, the casing according to one aspect of the invention comprises multiple supports in addition to the first casing body and the second casing body. The supports can be mounted to the housing to be encased. The casing can be mounted to the housing to be encased by way of the support. The first casing body can be mounted to the support and the second casing body to the first casing body. Because of this, it is not only a casing with simple construction that is provided, which can be easily mounted on the housing to be encased, but also a casing that ensures an unrestricted burst protection.

Preferentially, welding nuts are attached to the second sections of the supports via which the first casing body is mounted to the respective support. The first casing body comprises at least three radial casing segments, namely a radially outer, structure-reinforcing casing segment, a radially inner, thermally insulating casing segment, and at least one middle, structure-reinforcing casing segment arranged sandwich-like between the radially outer casing segment and the radially inner casing segment, wherein fastening screws extend through the radial casing segments of the first casing body into the welding nuts. This is advantageous for simply and reliably connecting the first casing body to the supports. In addition to the burst protection, which is provided by the radially outer casing segment and the or each middle casing segment, a good thermal insulation can be additionally provided, which is primarily provided by the radially inner casing segment.

Preferentially, further welding nuts via which the second casing body is mounted to the first casing body are attached to an inside of the radially outer casing segment of the first casing body, wherein these welding nuts engage in recesses of an adjoining middle casing segment. Further fastening screws extend through the or each radial casing segment of the second casing body into the welding nuts of the first casing body. These details serve for simply and reliably connecting the second casing body to the first casing body.

Each support comprises a basic body, wherein the first sections are angled relative to the basic body on first edges extending in the circumferential direction to radially inside, and wherein the second sections are angled relative to the basic body on second edges extending in the axial direction to radially outside. By way of this, the supports on the one hand can be optimally connected to the housing to be encased and on the other hand the first casing body can be optimally mounted to the supports.

### BRIEF DESCRIPTION OF THE DRAWINGS

Preferred further developments of the invention are obtained from the claims and the following description. Exemplary embodiments of the invention are explained in more detail by way of the drawing without being restricted to this. There it shows:

FIG. 1 is a perspective view of a casing or a turbocharger according to the invention together with a housing of the turbocharger to be encased;

FIG. 2 is the arrangement of FIG. 1 with a disassembled assembly of the casing;

FIG. 3 is the arrangement of FIG. 2 with disassembled second casing body of the casing;

FIG. 4 is the arrangement of FIG. 2 with disassembled first and second casing bodies of the casing;

FIG. 5 is a perspective view by way of an extract from the inside of the first casing body;

FIG. 6 is a perspective view by way of an extract from the inside of the first casing body with partly disassembled inner casing segment of the casing body;

FIG. 7 is an axial section by way of an extract through the arrangement of FIG. 1;

FIG. 8 is a further axial section by way of an extract through the arrangement of FIG. 1; and

FIG. 9 is a further axial section by way of an extract through the arrangement of FIG. 1.

### DETAILED DESCRIPTION OF THE PRESENTLY PREFERRED EMBODIMENTS

One aspect of the invention relates to a casing of a turbocharger and to a turbocharger having a casing.

The fundamental construction of a turbocharger is familiar to the person skilled in the art addressed here. Accordingly, a turbocharger comprises a turbine for expanding a first medium, in particular for expanding exhaust gas, and a compressor for compressing a second medium, in particular for compressing charge air, namely utilising the energy extracted in the turbine during the expansion of the first medium.

The turbine comprises a turbine rotor and a turbine housing. The compressor comprises a compressor rotor and a compressor housing. The turbine rotor and the compressor rotor are coupled via a shaft which is mounted in a bearing housing of the turbocharger, wherein the bearing housing is connected both to the turbine housing and also to the compressor housing.

In particular when during the operation for example the turbine rotor or the compressor rotor breaks, fragments of the same can strike through the respective housing, i.e. the turbine housing or the compressor housing and enter the surroundings. This has to be avoided for the purpose of which it is known to equip a turbocharger with a casing which surrounds the turbine housing and/or the compressor housing and/or the bearing housing of the turbocharger.

Preferentially, a separate casing each is employed in the region of the turbine housing and/or the compressor housing, which surrounds the respective housing of the turbocharger to be encased radially outside and axially outside at least in sections.

A casing does not only serve for providing a burst protection. Such a casing can also serve for thermal insulation and sound insulation.

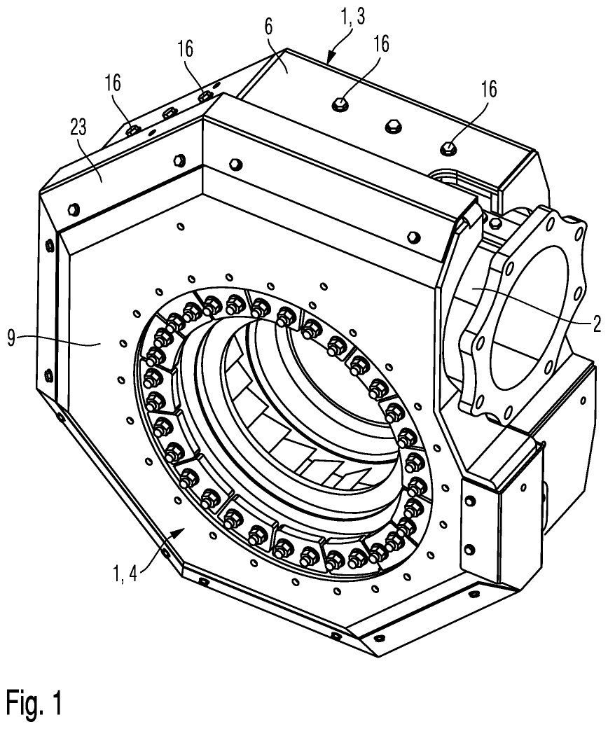

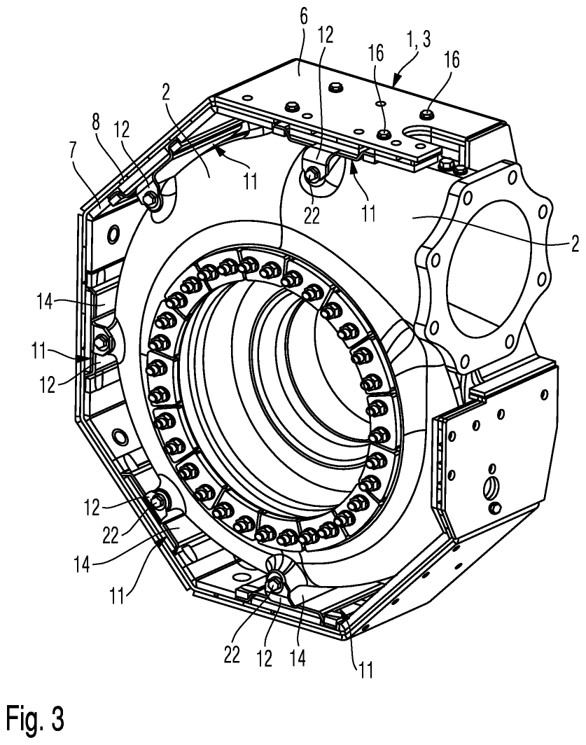

FIGS. 1 to 9 show different views and details of a casing 1 according to one aspect of the invention together with a housing 2 of a turbocharger to be encased, wherein the housing 2 shown in the figures is a turbine housing of a turbine of the turbocharger.

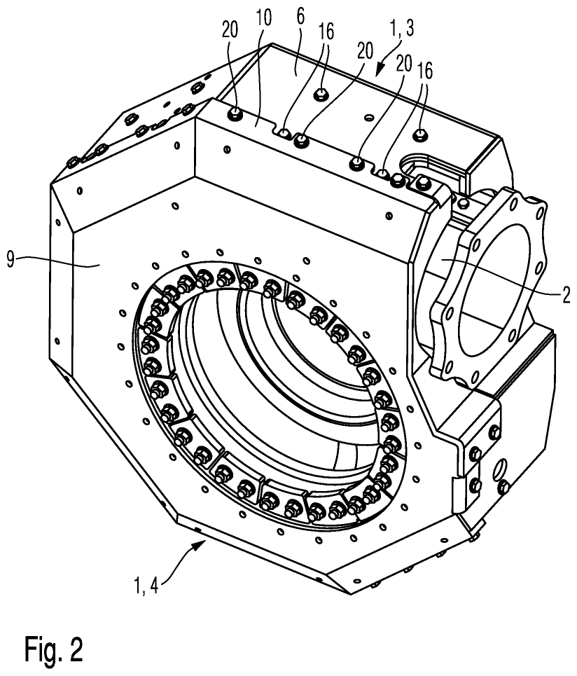

The casing 1 comprises multiple casing bodies. A first casing body 3, emanating from a first side of the housing 2 to be encased, can be pushed onto the housing 2 to be encased in the axial direction. Furthermore, the casing 1 comprises a second casing body 4 which, emanating from a second side of the housing 2 to be encased located opposite the first side can be pushed onto the housing 2 to be encased in the axial direction, namely in such a manner that the second casing body 4 covers the first casing body 3 radially outside in sections (see in particular FIG. 2).

The first casing body 3 comprises at least one axial casing body segment 5, which adjoins the housing 2 to be encased axially outside adjoining the first side of the housing 2 to be encased. Furthermore, the first casing body 3 comprises multiple radial casing body segments 6, 7, and 8 which adjoin the housing 2 to be encased radially outside and circulate in the circumferential direction. In the shown exemplary embodiment, the first casing body 3 comprises three radial casing body segments 6, 7, and 8, namely a radially outer, structure-reinforcing casing body segment 6, a radially inner, thermally insulating casing body segment 7 and a middle, likewise structure-reinforcing casing body segment 8 arranged sandwich-like between the radially outer casing body segment 6 and the radially inner casing body segment 7. Multiple middle radial casing body segments 8 can also be present between the radially outer casing body segment 6 and the radially inner casing body segment 7.

The second casing body 4, which emanating from a side located opposite the first side can be pushed onto the housing 2 to be encased in the axial direction, comprises at least one axial casing body segment 9, which adjoins the housing 2 to be encased adjoining the second side axially outside. Furthermore, this second casing body 4 comprises at least one radial casing body segment 10, which adjoins the housing 2 to be encased radially outside and circulates in the circumferential direction.

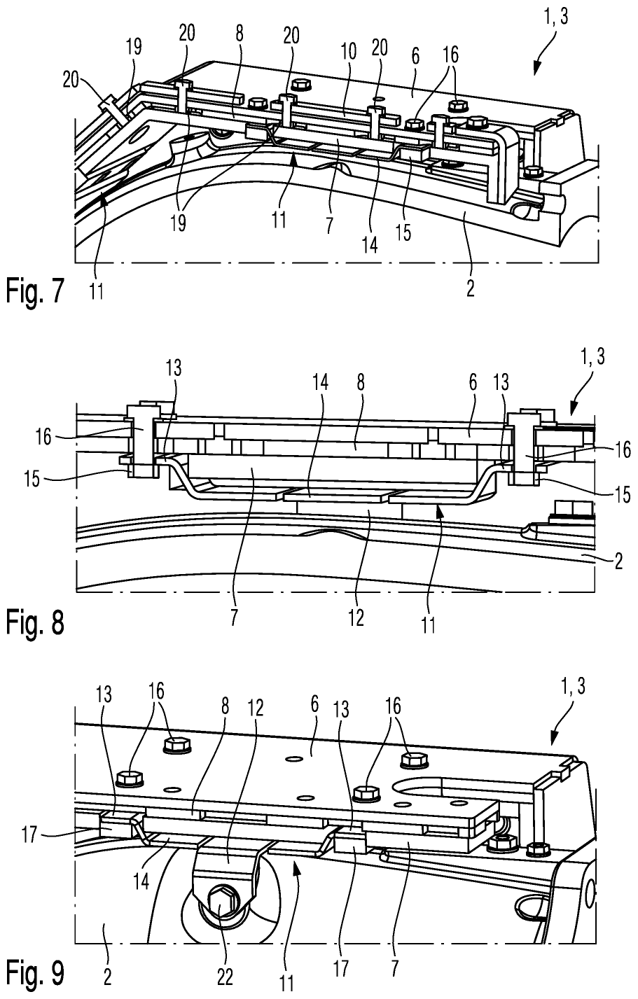

The second casing body 4 covers the first casing body 3 radially outside in sections namely in such a manner that the radial casing segment 10 of the second casing body 4 covers the radially outer casing segment 6 of the first casing body 3 radially outside in sections (see in particular FIGS. 2 and 7).

In addition to the first casing body 3 and the second casing body 4, the casing 1 comprises multiple supports 11. Each support 11 comprises first sections 12 via which the respective support 11 can be mounted to the housing 2 to be encased. Furthermore, each support 11 comprises second sections 13, via which the first casing body 3 can be mounted to the respective support 11.

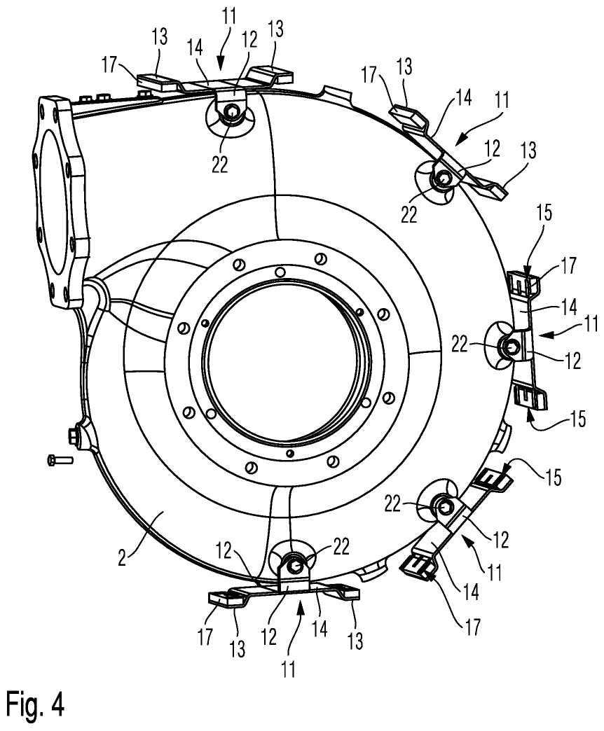

As is best evident from FIG. 4, each of the supports 11 comprises a basic body 14.

The first sections 12, which serve for mounting the respective support 11 on the housing 2 to be encased, are angled relative to the basic body 14 of the respective support 11 to radially inside, namely on edges of the basic body 14 extending in the circumferential direction of the casing 1 or of the housing 2 to be encased.

The second sections 13 of the respective support 11, on which the first casing body 3 of the casing 1 can be mounted, are angled relative to the basic body 14 of the respective support 11 to radially outside, namely on edges of the basic body 14 extending in the axial direction of the casing 1 or of the housing 2 to be encased.

On the second sections 13 of each support 11, welding nuts 15 are attached, namely on a side of the respective second section 13 of the respective support 11 facing the housing 2 to be encased. By way of these welding nuts 15, which are connected to the respective second section 13 of the respective support 11 by welding, the first casing body 3 of the casing 1 can be connected to the supports 11, namely in such a manner that fastening screws 16 extend from radially outside through the radial casing segments 6, 7 and 8 of the first casing body 3 into the welding nuts 15.

Adjoining the welding nuts 15, thermally insulating bodies 17 act on the second sections 13 of the supports 11.

In order to provide a particularly compact design of the casing 1, the radially inner casing segment 7 of the first casing body 3 of the casing 1 according to FIG. 6 comprises recesses 18, into which in the mounted state of the casing 1 the second sections 13 of the supports 11 extend.

The thermally insulating bodies 17, which act on the second sections 13 of the supports 11, then insulate in particular where, because of these recesses 18, the thermally insulating effect of the radially inner casing segment 7 of the first casing body 3 is interrupted.

To mount the second casing body 4 to the first casing body 3, further welding nuts 19 are attached by welding on an inside of the radially outer casing segment 6 of the first casing body 3, via which the second casing body 4 is mounted to the first casing body 3. Further fastening screws 20 extend through the or each radial casing segment 10 of the second casing body 4 into these further welding nuts 19 of the first casing body 3. These further fastening screws 20, which serve for mounting the second casing body 4 on the first casing body 3, accordingly extend, just like the fastening screws 16, which serve for mounting the first casing body 3 to the supports 11, from radially outside to radially inside.

The fastening screws 16, which serve for mounting the first casing body 3 to the supports 11, extend through the radial casing segments 6, 7, and 8 of the first casing body 3 into the welding nuts 15, which are attached to the sections 13 of the support 11. By contrast, the fastening screws 20, which serve for mounting the second casing body 4 on the first casing body 3, extend through the or each radial casing segment 10 of the second casing body 4 and through the radially outer casing segment 6 of the first casing body 3 into the welding nuts 19, which are attached to the first casing body 3.

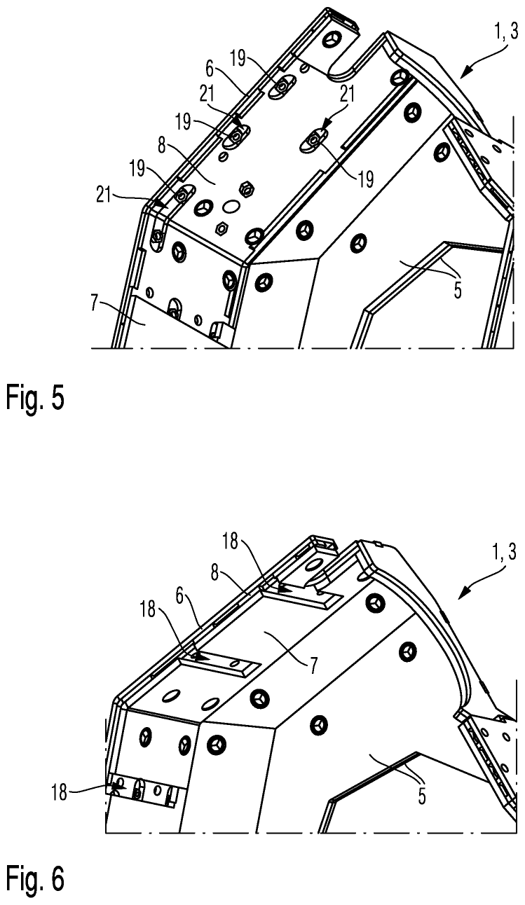

To ensure a compact design of the casing, the welding nuts 19, which are attached to the radially outer casing segment 6 of the first casing body 3 by welding as is evident in FIG. 5, are positioned in recesses 21 of the middle casing segment 8 of the first casing body 3 adjoining the radially outer casing segment 6.

As already explained, the first casing body 3 comprises at least one axial casing segment 5 and multiple radial casing segments 6, 7, and 8. In the shown exemplary embodiment, the first casing body 3 comprises not only multiple radial casing segments 6, 7, 8 but also multiple axial casing segments 5, namely at least an axially outer casing segment 5 with structure-reinforcing properties and at least one axially inner casing segment 5 with thermally insulating properties. The second casing body 5 comprises at least one axial casing segment 9 and at least one radial casing segment 11. Preferentially, the second casing body 4 comprises two axial casing segments 9 and two radial casing segments 11, namely in each case an outer casing segment with structure-reinforcing properties and an inner casing segment with thermally insulating properties.

Both the axial casing segments 5 and also the radial casing segments 6, 7, and 8 of the first casing body 3 can be assembled from multiple part sections or embodied in one piece. The same applies to the casing segments 9, 10 of the second casing body 4. These can be embodied in one piece or assembled from multiple part sections.

At least the outer axial and outer radial casing segments of each casing body 14 are embodied together in one piece and merge into one another via a section running angled relative to the same.

Those casing segments, which have structure-reinforcing properties, are preferentially produced from stainless steel. Those casing elements, which have thermally insulating properties, are preferentially produced from a glass fibre material.

As already explained, the supports 11 are connected to the housing 2 to be encased at their first sections 13 angled relative to the basic body 14 of the respective support 11 to radially inside, namely via fastening screws 22 which extend in the axial direction through the second sections 12 of the respective support 11 into the housing 2 to be encased.

In addition, the casing 1 comprises a covering element 23. This covering element 23 covers the fastening screws 16, 20 in the region in which the second casing body 4 covers the first casing body 3 radially outside in sections, via which fastening screws 16, 20 in this covering region on the one hand the first casing body 3 is connected to the supports 11 and on the other hand the second casing body 4 is connected to the first casing body 3. Should, during the operation, the fastening screws 16, 20 fail because of high forces, the fastening screws are retained by the covering element 23 so that the fastening screws cannot enter the surroundings and injure persons present in the surroundings. The covering element 23 is connected to the second casing body 4 of the casing 1, preferentially screwed.

The multiple supports 11 are distributed over the circumference of the first casing body 3 of the casing 1 or over the circumference of the housing 2 to be encased.

One aspect of the invention, furthermore, relates to a turbocharger having a casing 1 according to one aspect of the invention. With a turbocharger according to one aspect of the invention, the casing 1 serves to surround and thus encase the turbine housing or the compressor housing and if appropriate sections of a bearing housing positioned between turbine housing and compressor housing radially outside and axially outside at least in sections.

Obviously, the casing 1 comprises recesses for a passage-through of shafts and connecting flanges of the housing 2 to be encased.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A casing of a turbocharger, configured to surround a housing at least in sections, which is one or more of a turbine housing, a compressor housing, and a bearing housing of the turbocharger, comprising:
a first casing body, which emanating from a first side of the housing to be encased, is configured to be pushed onto the housing to be encased in an axial direction, wherein the first casing body comprises:
at least one first axial casing segment, which adjoins the first side of the housing axially outside; and
multiple first radial casing segments, which adjoin the housing to be encased radially outside;
a second casing body, which emanating from a second side of the housing to be encased, is configured to be pushed onto the housing in the axial direction, wherein the second casing body comprises:
at least one second axial casing segment, which adjoins the second side of the housing to be encased axially to the outside; and
at least one second radial casing segment, which adjoins the housing to be encased radially outside, that covers the first casing body radially outside in sections and is connected to the first casing body;
multiple supports, wherein each support comprises:
first sections, via which a respective support is mounted to the housing to be encased; and
second sections, via which the first casing body is mounted to the respective support.

2. The casing according to claim 1, further comprising:
first welding nuts are attached on the second sections of each support via which the first casing body is mounted to the respective support.

3. The casing according to claim 2, wherein the first casing body comprises at least three first radial casing segments, configured as:
a radially outer casing segment, that is structure-reinforcing;
a radially inner casing segment, that is thermally insulating; and
at least one middle casing segment that is structure reinforcing and arranged sandwich-like between the radially outer casing segment and the radially inner casing segment, wherein first fastening screws extend through the first radial casing segments (6, 7, 8) of the first casing body into the first welding nuts.

4. The casing according to claim 3, wherein on the second sections of the supports, configured to engage in first recesses of the radially inner casing segment, thermally insulating bodies are mounted adjacent to the first welding nuts.

5. The casing according to claim 3, wherein second welding nuts are attached on an inside of the radially outer casing segment of the first casing body, via which the second casing body is mounted to the first casing body, wherein the second welding nuts engage in second recesses of an adjoining middle casing segment.

6. The casing according to claim 5, wherein second fastening screws extend through the or each radial casing segment of the second casing body into the second welding nuts of the first casing body.

7. The casing according to claim 6, further comprising a covering element for the first fastening screws and the second fastening screws.

8. The casing according to claim 1, wherein each support comprises a basic body, wherein the first sections are angled relative to the basic body on first edges extending in a circumferential direction to radially inside, and wherein the second sections are angled relative to the basic body on second edges extending in the axial direction, to radially outside.

9. The casing according to claim 1, wherein the multiple supports are distributed over a circumference of the first casing body.

10. A turbocharger, comprising:
a turbine for expanding a first medium;
a compressor for compressing a second medium utilising energy extracted in the turbine during expansion of the first medium;
a bearing housing arranged between and connected to a turbine housing of the turbine and a compressor housing of the compressor; and
a casing surrounding at least one of the turbine housing, the compressor housing, and the bearing housing comprising:
a first casing body, which emanating from a first side of the housing to be encased, is configured to be pushed onto the housing to be encased in an axial direction, wherein the first casing body comprises:
at least one first axial casing segment, which adjoins the first side of the housing axially outside; and
multiple first radial casing segments, which adjoin the housing to be encased radially outside;
a second casing body, which emanating from a second side of the housing to be encased, is configured to be pushed onto the housing in the axial direction, wherein the second casing body comprises:
at least one second axial casing segment, which adjoins the second side of the housing to be encased axially to the outside; and
at least one second radial casing segment, which adjoins the housing to be encased radially outside, that covers the first casing body radially outside in sections and is connected to the first casing body;
multiple supports, wherein each support comprises:
first sections, via which a respective support is mounted to the housing to be encased; and
second sections, via which the first casing body is mounted to the respective support.
